(19) United States
(12) Patent Application Publication
(10) Pub. No.: US 2004/0257331 A1
(43) Pub. Date: Dec. 23, 2004

(54) 3 Dimensional input device

(76) Inventor: Kazutora Yoshino, Eden Prairie, MN (US)

Correspondence Address: KAZUTORA YOSHINO, 7227 Divinity Lane, Eden Prairie, MN, 55346, US

(21) Appl. No.: 10/465,707

(22) Filed: Jun. 19, 2003

(51) Int. Cl. G09G 5/00

(52) U.S. Cl. 345/156

(57) ABSTRACT

The 3 dimensional input device that can input 3 dimensional object images that are mono-color, color, small, big, inside and outside. The device input multi-layers of 2 dimensional images in the different depths of field with varifocal lens. It registers colored 2 dimensional images, corresponding depths of 2 dimensional images and finds maximum contrast ratios of pixels in 2 dimensional images. Then the device to find out color, x-y and the depth of surface object, and thereof it finds out 3 dimensional information (data) of the object.

### FEDERALLY SPONSORED RESEARCH

Not Applicable

### SEQUENCE LISTING OR PROGRAM

Not Applicable

### BACKGROUND OF INVENTION

1. Background—Field of Invention

This invention relates to the image input & display devices, specifically to 3D scanner, 3D digitizer that are used for inputting the 3 dimensional object or images, and 3DTV, hologram, stereo display device that are used for displaying the 3 dimensional object or images.

2. Background—Description of Prior Art

In the conventional way, it was difficult to scan 3D object without projecting special beam like laser beam to object. In reality, giving laser beam is impractical if object is outside or big. Also, these devices are very expensive. Laser Design, Inc. (LDI) sells the 3D scanner about $60,000, and Minolta sells 3D digitizer about $20,000 each. This is not what many people cannot afford to scan 3D images.

The method to scan 3 dimensional image can be done in taking point clouds and convert to surface. U.S. Pat. No. 6,512,518 (2002) Demsdale, Jerry disclose this method. But this needs laser and takes only-point clouds.

Also, there wasn't many 3D image input devices that can compatible with 3D image display.

The method to project the 2 dimensional image to semi-transparent plates to create 3 dimensional image are difficult to show the 3 dimensional virtual images in the space only by light. These are like U.S. Patent application 60/004,111 (1995), U.S. Pat. No. 5,394,202 (Deering) and U.S. Pat. No. 5,907,312 (Sato, et al).

In the Lab note made by Kazutora Yoshino (May 30, 1995), or in U.S. Patent application 60/004,111 (1995), or in U.S. Pat. No. 6,302,542 (1999) shows that the movement of panel/screen with 2D image projected on it can make 3D images. They don't show how fast the panel/screen should move. They don't show mechanism how to move the panels/screens effectively in order to make the 3D image realistic. Also, users cannot touch to the 3D image.

In U.S. Pat. Nos. 5,956,172 and 5,684,621 by Elizabeth Anne Downing, it shows the way to display the 3D image in a crystal. But user cannot touch to the 3D image.

### OBJECT AND ADVANTAGES

This invention has advantages relative to prior art in

1. The device can input 3D data without special beam projected on object.

2. The device can input 3D data in color.

3. The device can input big 3D data,

4. The device can input 3D data outside

5. The device can input 3D data that can be easily convert to the data for 3D display.

6. The device can input 3D data reasonably fast.

7. The device is relatively inexpensive.

### SUMMARY

Recent development enabled to make fast process of data and fast varifocal means. SONY developed fast varifocal lens using liquid crystal lens.

An example of my invention is composed of a (computer) video camera with high-resolution varifocal lens and computer to process those data are used.

General concept of this device is the following:

A1) First, input 2 dimensional images with different depth using high-resolution vanifocal lens. (This can be done by one camera from one angle, multiple angle or multiple cameras.) Register each value of focus or each position/length of motion of lens when inputting each 2 dimensional image.

A2) Second, find out the depth at each pixel out of 2 dimensional images. This can be done in finding out the highest contrast point at each pixel. In order to find out the contrast, it can simply compare the red, green or blue intensity value to its neighbor(s) red, green, or blue intensity value respectively. The biggest difference is the highest contrast. Also black and white contrast ratio can be used as well.

Example formula for contrast is

Contrast=Absolute|G1−GN1| (It can be |R1−RN1| or |B1−BN1|);

OR

Contrast=Square (R1\hat{ }2+G1\hat{ }2+B1\hat{ }2)−Square (RN1\hat{ }2+GN1\hat{ }2+BN1\hat{ }2)

Where R1, G1 and B1 are the red, green and blue intensity value of surface of object at the original pixel respectively. And RN1, GN1 and BN1 are the red, green and blue intensity value of surface of object at its neighbor pixel respectively.

This can be done in various methods:

### EXAMPLE 1

i) at each pixel on x-y (in 2 dimensional image), find out the highest contrast point to its neighbors in those inputted 2 dimensional images.

ii) the corresponding value of focus or position/length of motion of lens is the depth of the surface of object at each pixel.

### EXAMPLE 2

i) At the first 2 dimensional image plane, register all contrast ratios for all pixels.

ii) at next 2 dimensional image plane, if any pixel is greater, register as maximum contrast ratio at the pixel.

iii) repeat to ii) until the end of all 2 dimensional image plane.

iv) the depth of the surface of object at the pixel is the plane depth of the maximum value. (The plane depth is registered at first when those 2 dimensional images are inputted.)

A3) Optionally, after 3 dimensional data is created, those data are slice to outlines and send to display device.

This device can input (& display) the 3 dimensional objects or images in real time (run time).

### DRAWINGS

Drawing Figures

FIG. 1 shows the diagram of 3 dimensional input device.

FIG. 2 shows the diagram of image plane with original pixel and neighbors.

FIG. 3 shows the diagram of 3 dimensional input device and (2D/3D) display.

### REFERENCE NUMERALS IN DRAWINGS

1) The 3 dimensional input device

2) a video camera with high-resolution varifocal lens

3) high-resolution varifocal lens

4) a computer

5) object

7) 2 dimensional image files

10) an image plane with original pixel and neighbor pixels

11) neighbor pixels

12) an original pixel

### DETAILED DESCRIPTION

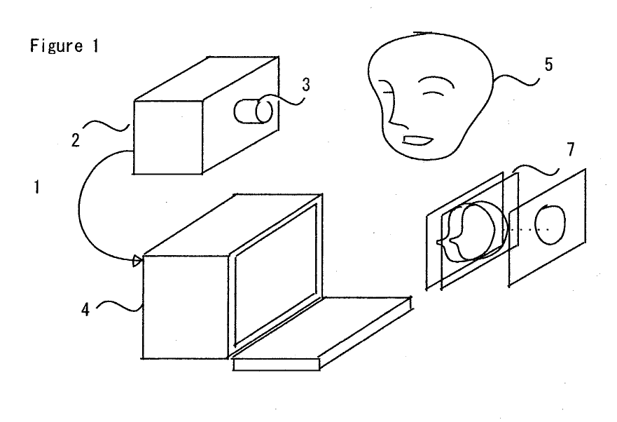

### DESCRIPTION—FIG. 1—PREFERRED EMBODIMENT

A preferred embodiment of the 3 dimensional input device {1}. 3D object {5} is scanned by high-speed image input device means {2} with high-speed varifocal lens means {3}. The 2 D data and depth information is transferred to driver and computer means {4}. Multiple 2 D images with various depth of field is captured {7} (It can be Multiple 2 D images with right focus with registered depth)

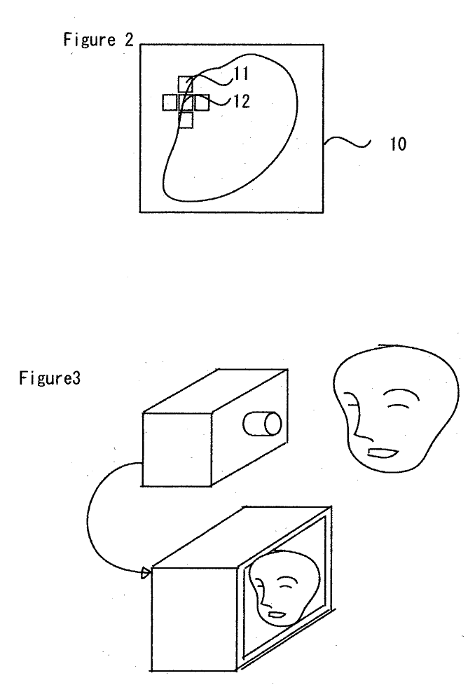

### FIG. 2—ADDITIONAL EMBODIMENTS

A 2 D image {10} panel with original pixel {12} and its neighbors {11}.

### FIGS. 3—ALTERNATIVE AND OTHER EMBODIMENT—AND EXAMPLES

A 3 D input device and 3 D display device

Advantages

This invention has advantages relative to prior art in

8. The device can input 3D data without special beam projected on object.

9. The device can input 3D data in color

10. The device can input big 3D data

11. The device can input 3D data outside

12. The device can input 3D data that can be easily convert to the data for 3D display.

13. The device can input 3D data reasonably fast.

14. The device is relatively inexpensive.

Operation—FIG. 3

User can simply take the 3 dimensional image-object by the 3 dimensional input device.

The rest is computer's work. Then 3D image come out to the display screen, it can be saved to file for recording or it can be sent to proper location (like computer).

Users can command to computers by interacting with the 3 dimensional visual image input like hand signals. Multiple users can use these devices through networking like Internet as well.

Conclusion, Ramifications, and Scope

By this invention, users can input the 3 dimensional objects or images, inexpensively, and such image (data) can be saved, transferred, or displayed for users.

I claim:

1. Three dimensional input device means composed of the group consisting of
i) High-speed two dimensional image input device means
ii) High-speed varifocal lens means
iii) Driver and computer means

2. the invention of claim of [1], wherein said High-speed two dimensional image input device means composed of the group consisting of
two dimensional image input device,
two dimensional image input unit, array of photodiodes or phototransistors,
digital light processor units

3. the invention of claim of [2], wherein said high-speed varifocal means composed of the group consisting of
varifocal lens,
mechanical varifocal lens, liquid crystal varifocal lens, electro-optic varifocal lens, acousto-optic varifocal lens, piezoelectric varifocal lens, magnetic field driven varifocal lens composed of the group consisting of magnet, coil, lens

4. the claim of [2], wherein said driver and computer means composed of the group consisting of signal drivers, data transfer unit, data processing unit, software, software to find out the x-y and z information, computer

5. Three dimensional input device means composed of the group consisting of
i) X-Y finding means
ii) Depth finding means
iii) Surface Intensity finding means

6. the claim of [2], wherein said X-Y finding means composed of the group consisting of
two dimensional image input device, particle projection device and
receiving images device, light projection and receiving images, visual,
ultraviolet, infrared light projection and receiving images device, electron beam projection and receiving images device, x-ray projection and
receiving images device, sound projection and receiving images device,
ultrasound projection and receiving images device.

7. the claim of [2], wherein said depth finding means composed of the group consisting of
contrast finding device, maximum contras finding means, parallax finding device

8. the claim of [2], wherein said Surface Intensity finding means composed of the group consisting of
color intensity finding device, black and white intensity finding device,
beam intensity finding device
